(19) United States
(12) Patent Application Publication
(10) Pub. No.: US 2012/0286048 A1
(43) Pub. Date: Nov. 15, 2012

(54) PLUG-AND-PLAY BARCODE SCANNER

(76) Inventors: Kuo-Nien Liu, New Taipei City (TW); Kenneth Liou, New Taipei City (TW)

(21) Appl. No.: 13/107,479

(22) Filed: May 13, 2011

(51) Int. Cl. G06K 7/01; G06K 7/14

(52) U.S. Cl. 235/462.48

(57) ABSTRACT

A plug-and-play barcode scanner is plugged into an operable electronic apparatus, e.g. a computer or a portable electronic apparatus and after the plugging is completed, the plug-and-play barcode scanner is operative to scan a barcode. The plug-and-play barcode scanner is formed of a micro-scanner designed in combination with a plug-and-play transmission interface module, so that the barcode scanner tends to become more lightweight, more convenient and more practicable and is beneficial to the popularization of managing markets of commodity marketing and sales with the barcode in the future.

### BACKGROUND OF THE INVENTION

1. Field of the Invention

The present invention relates to a plug-and-play barcode scanner which is operative to scan a barcode, and more particularly to a micro plug-and-play barcode scanner.

2. Related Art

A barcode scanner (or barcode reader) is implemented in a wide range of business, e.g. inventory management in logistics and commodity management of a shopping center. Currently, the barcode is further applied in marketing areas such as directory advertisement and TV-shopping and is introduced in the whole marketing process. At an early stage, generally the barcode scanner is mostly distributed at the merchant side and the barcode scanner is operated by the merchant to count the number of commodities and the total charges before the ordinary end consumer finishes shopping, and finally the consumer pays according to the counting result. Therefore, in consideration of the changes of the current marketing market and the convenience of the advertisement, if the function of the barcode can be flexibly applied, great changes to the whole consumer market will occur and considerable business opportunities will arise.

The business opportunities derived from the applications of the barcode and the barcode scanner in consideration of the end consumer will overturn the existing thinking of the whole market. For example, when the end consumer is browsing a commodity catalog, if the barcode integrates the information contents, the end consumer can operate a portable and easy-to-operate barcode scanner to scan the barcode of the commodity. In this manner, the end consumer can not only acquire the complete information of the commodity quickly but also, under an effective and complete mechanism, the end consumer can pay instantly. For example, when browsing the commodity catalog, if the end consumer finds the commodity that he/she intends to purchase, the end consumer can operate the barcode scanner to scan the barcode provided in the catalog, and then an electronic apparatus (such as a notebook computer or a mobile communication apparatus) connected to the barcode scanner is used to synchronously interpret the acquired barcode information including the specification and price of the commodity. If a payment system related to the cash flow is further combined, the consumer can pay after acquiring the complete information, thereby realizing a quick consuming process.

In view of the above, this business marketing concept tends to be gradually shaped along with the popularization of the portable electronic apparatus. However, the application of the barcode scanner is not popularized to the end consumer, so even if the concept is formed at the part of the business marketing, in practice, the concept cannot be realized in the absence of the cooperation between matching software and hardware. Therefore, to effectively apply the barcode in a larger consumer market, the popularization of the barcode scanner is a crucial factor.

### SUMMARY OF THE INVENTION

Accordingly, the present invention is directed to provide a plug-and-play barcode scanner which is portable and easy-to-operate, can be used in combination with an electronic apparatus and has the plug-and-play function.

In order to achieve the purpose, the present invention provides a barcode scanner designed in the microminiaturization and in combination with an information transmission interface (e.g. USB), which enables the barcode scanner to be connected to an electronic apparatus simply and quickly, thereby greatly saving the manufacturing cost, and also the price of the whole set of the barcode scanner is reasonable and the barcode scanner is characterized by the microminiaturization, which promotes the realization of the popularization of the barcode scanner.

### BRIEF DESCRIPTION OF THE DRAWINGS

The present invention will become more fully understood from the detailed description given herein below for illustration only, and thus are not limitative of the present invention, and wherein:

FIG. 1 is a three-dimensional outside view of the present invention;

FIG. 2 is a schematic combination view of components of the present invention;

FIG. 3 is an implementation schematic view (1) of the present invention;

FIG. 4 is an implementation schematic view (2) of the present invention;

FIG. 5 is an implementation schematic view (3) of the present invention;

FIG. 6 illustrates another preferable embodiment (1) of the present invention;

FIG. 7 illustrates another preferable embodiment (2) of the present invention; and

FIG. 8 is an implementation schematic view of the embodiment (2).

### DETAILED DESCRIPTION OF THE INVENTION

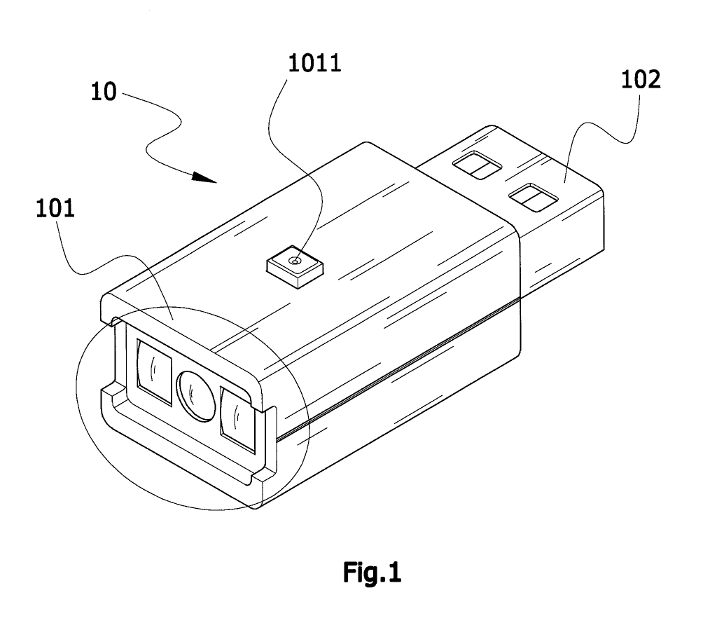

FIG. 1 is a three-dimensional outside view of the present invention. Referring to FIG. 1, a plug-and-play barcode scanner 10 is mainly formed of a barcode scan module 101 and a transmission interface module 102. The barcode scan module 101 at least includes an operable operating key 1011. Additionally, the transmission interface module 102 is configured at one end of the barcode scan module 101 and may be any transmission interface (e.g. USB transmission interface). Therefore, before operating the plug-and-play barcode scanner 10, firstly, the transmission interface module 102 is plugged into a corresponding electronic apparatus such as a notebook computer and a portable communication apparatus, the plug-and-play barcode scanner 10 establishes an information link with the electronic apparatus, and then through certain operations, the barcode scan module 101 may be operated to further scan a barcode.

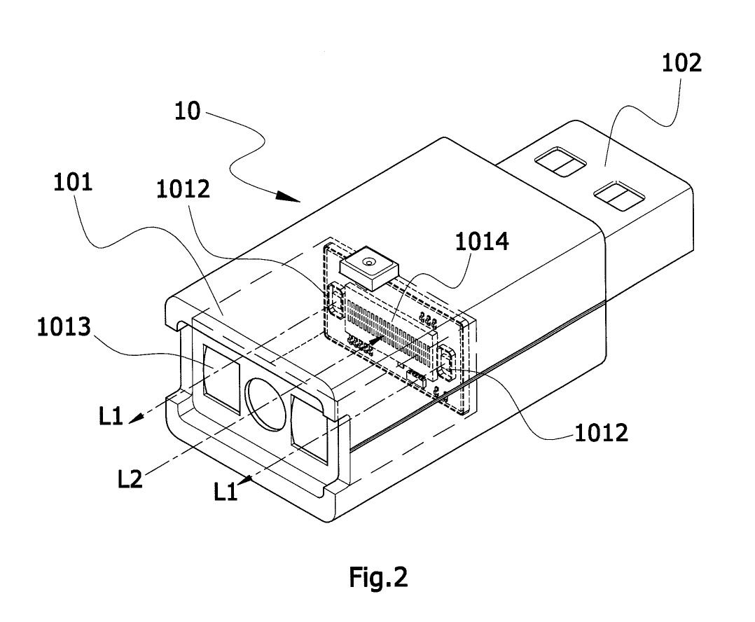

FIG. 2 is a schematic combination view of components of the present invention. Referring to FIG. 2, the barcode scan module 101 is an entity designed in microminiaturization, and includes a light-emitting source 1012 which can produce a light source L1. The light source L1 is transmitted from a lens set 1013 configured at a front end, so that the light source L1 is perpendicularly incident to a barcode B1 (not shown) during scanning. Additionally, a receiving unit 1014 may receive a reflected light L2 produced after the light source L1 is projected on the barcode B1, and convert the received reflected light L2 into light information which is then transferred by the transmission interface module 102 to the electronic apparatus (not shown), so as to perform an interpretation procedure. Furthermore, an interpretation function may also be directly installed at the receiving unit 1014, so that the light information can be directly interpreted and then transferred to the electronic apparatus.

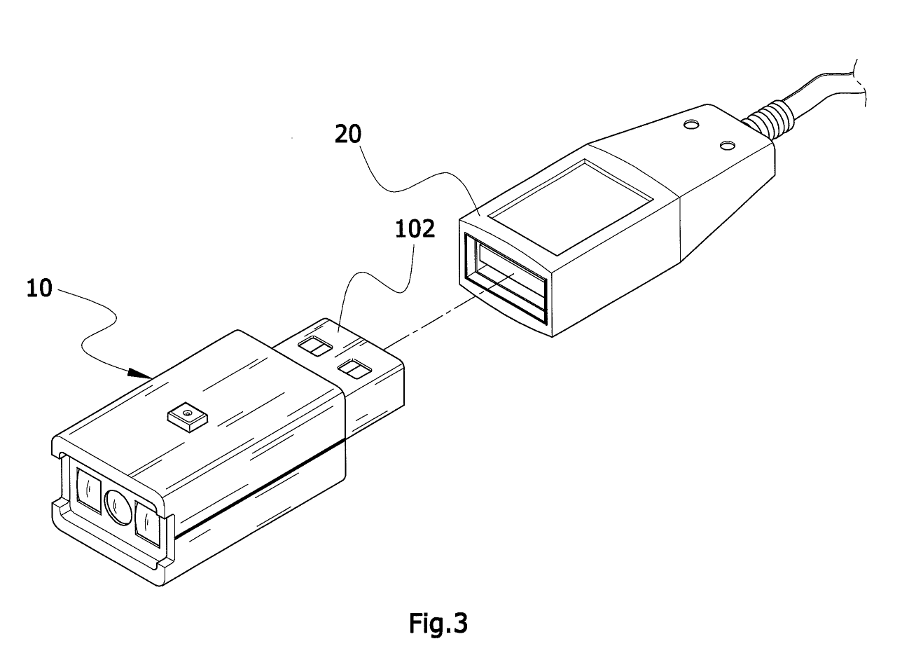

FIG. 3 is an implementation schematic view (1) of the present invention. Referring to FIG. 3, the plug-and-play barcode scanner 10 establishes the information link with the electronic apparatus via the transmission interface module 102. As shown, the plug-and-play barcode scanner 10 may establish the information link with the electronic apparatus via a transmission line 20 with a compatible transmission specification. Also, the electronic apparatus is not limited in the type and may be for example, a computer, a portable mobile communication apparatus or the like. Mainly, an application for linking the plug-and-play barcode scanner 10 can be installed in the electronic apparatus. That is to say, when the plug-and-play barcode scanner 10 is operated, the barcode information obtained by scanning can be read by the linked electronic apparatus or a result thereof can be presented.

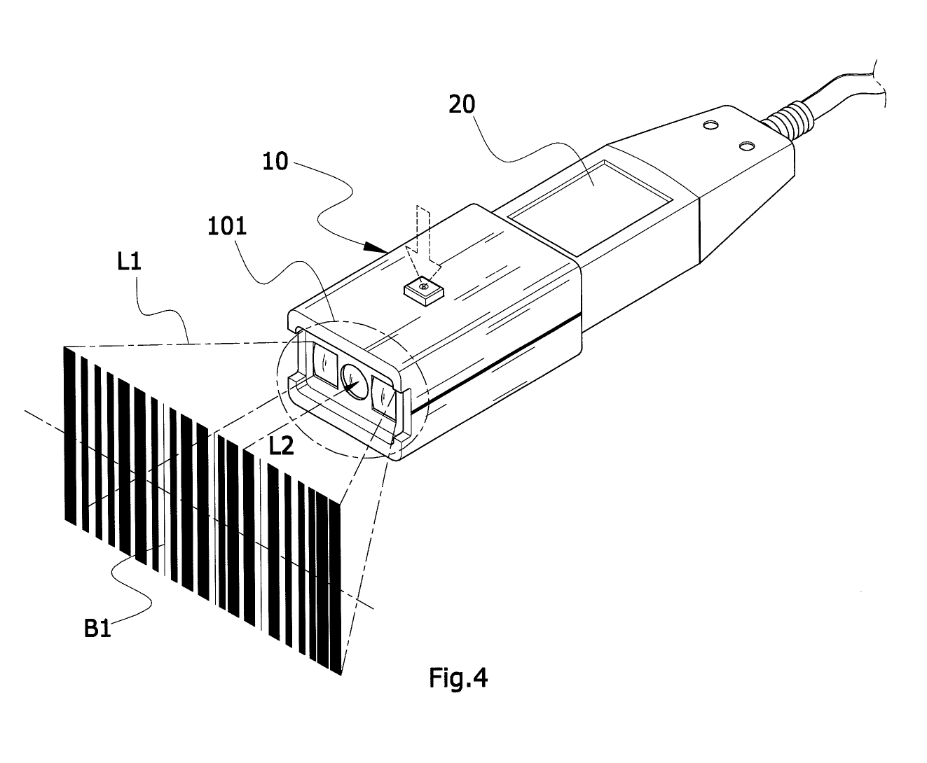

FIG. 4 is an implementation schematic view (2) of the present invention. Referring to FIG. 4, after the plug-and-play barcode scanner 10 establishes the information link with the electronic apparatus via the transmission line 20, an operator can hold the plug-and-play barcode scanner 10 by hand to scan the barcode. As shown, when the operator intends to scan the barcode, the operator only needs to press down the operating key 1011 to actuate the barcode scan module 101, and then the barcode scan module 101 emits the scanning light source L1 to scan the barcode B1. The reflected light L2 produced in scanning is received by the receiving unit 1014 (referring to FIG. 2) of the barcode scan module 101 and is interpreted.

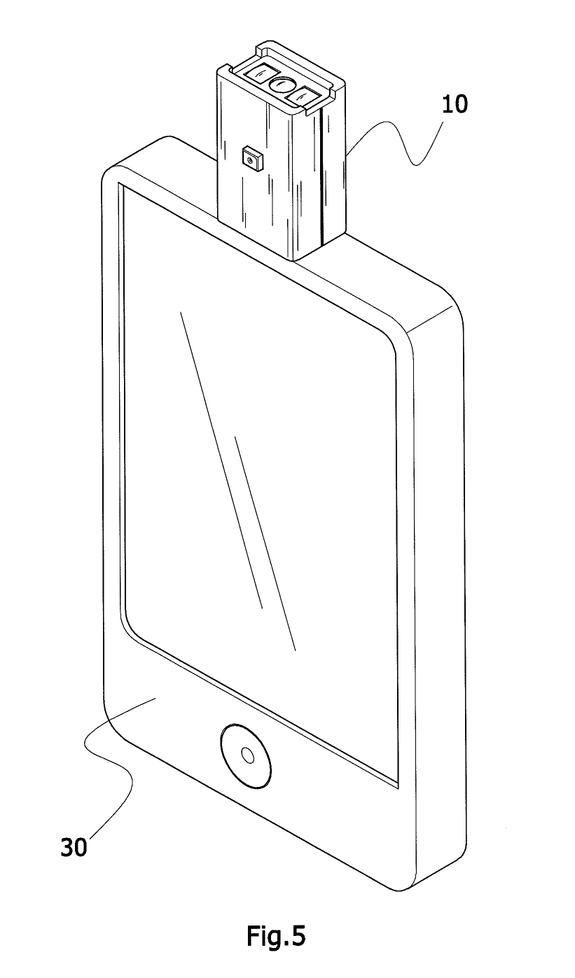

FIG. 5 is an implementation schematic view (3) of the present invention. Referring to FIG. 5, an electronic apparatus 30 has a linking apparatus on one end, in which the linking apparatus has the same transmission specification as that of the transmission interface module 102 of the plug-and-play barcode scanner 10. In this manner, the plug-and-play barcode scanner 10 can be directly plugged into the electronic apparatus 30. Also, an application for driving the plug-and-play barcode scanner 10 to be operated is installed in a system of the electronic apparatus 30, and after the plug-and-play barcode scanner 10 is plugged, the plug-and-play barcode scanner 10 is driven by the application to establish an information link with the electronic apparatus. After the link is established, a user may hold the plug-and-play barcode scanner 10 by hand to scan the barcode B1 (referring to FIG. 4).

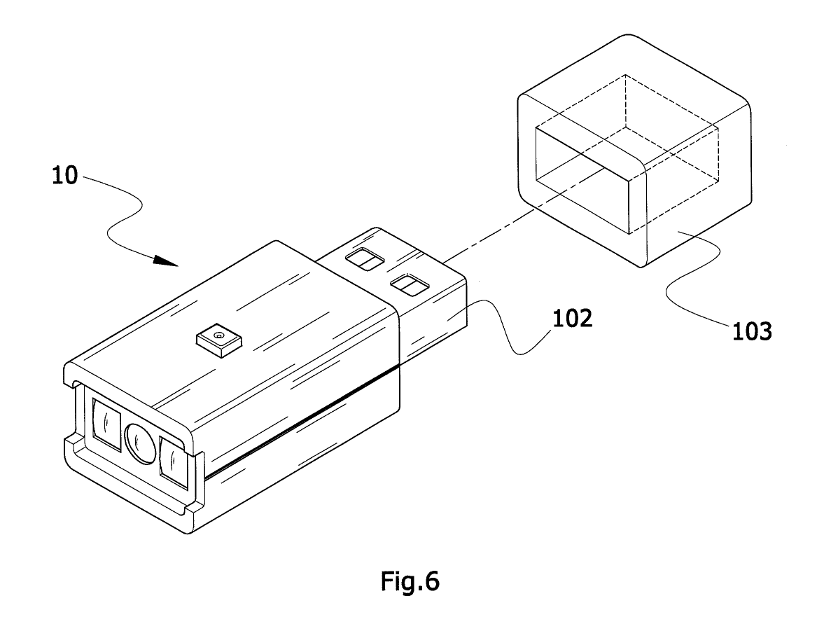

FIG. 6 illustrates another preferable embodiment (1) of the present invention. Referring to FIG. 6, the plug-and-play barcode scanner 10 further includes a cover body 103 which covers the transmission interface module 102 for effectively protecting the transmission interface module 102.

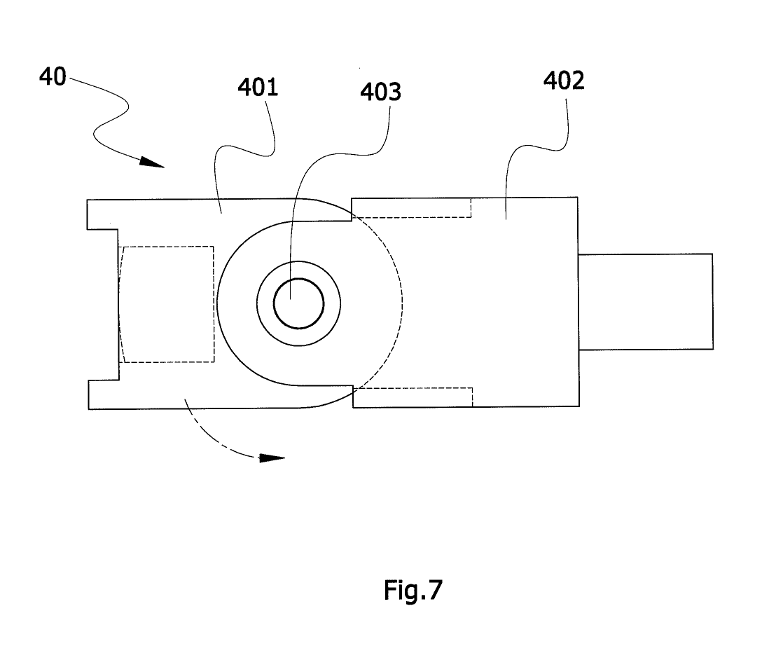

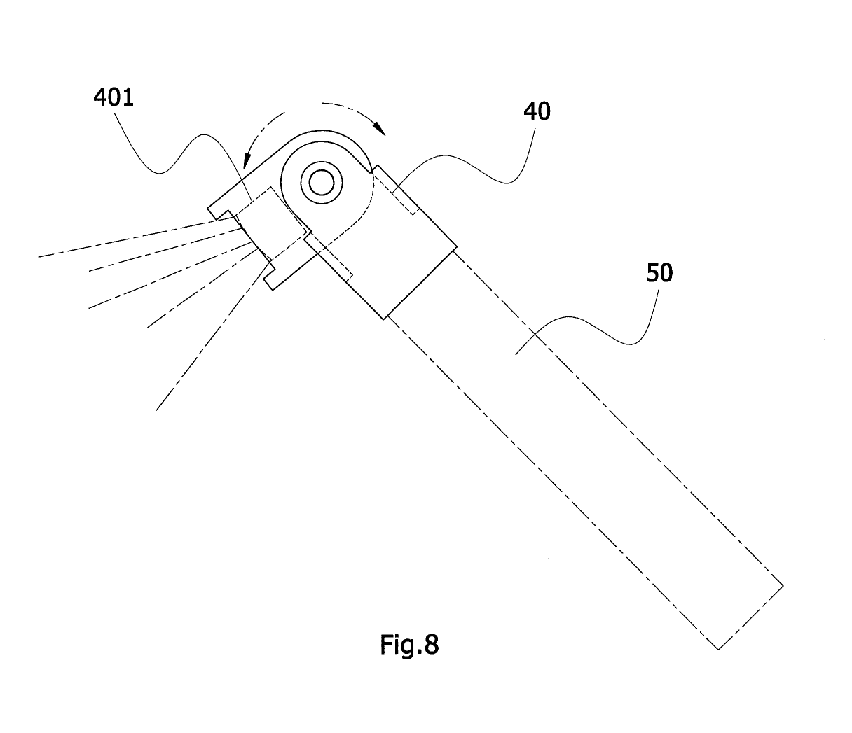

FIG. 7 illustrates another preferable embodiment (2) of the present invention. Referring to FIG. 7, a plug-and-play barcode scanner 40 is mainly formed of a barcode scan module 401 and a transmission interface module 402. Additionally, the barcode scan module 401 and the transmission interface module 402 are independent parts respectively, which are electrically connected via an electrical connecting wire. A pivot 403 is configured between the two parts so that the two parts can rotate relative to each other at a proper angle. Subsequently, FIG. 8 is an implementation schematic view of the embodiment (2). Referring to FIG. 8, after the plug-and-play barcode scanner 40 establishes the information link with an electronic apparatus 50, the operator may conduct the barcode scanning. Additionally, in this embodiment, the barcode scan module 401 may be further poked by the operator according to requirements during a practical operation so as to form a proper angle with the electronic apparatus 50, so that the user in operation can conduct the barcode scanning at the optimal scanning angle.

In summary, in the present invention, the barcode scan module designed in the microminiaturization in combination with the transmission interface module is mainly utilized, so that it is convenient to carry the entire barcode scan module. Moreover, the present invention further takes the practicability into consideration. The transmission interface module establishes the information link with the popularized electronic apparatus, which not only reduces the cost but also reduces the complexity in use. Accordingly, the present invention is implemented to provide the plug-and-play barcode scanner which is conveniently portable and operable, can be used in combination with the electronic apparatus, and has the plug-and-play function. The present invention is beneficial to the rapid popularization of the barcode in the market of general business applications.

The above descriptions are merely preferable embodiments of the present invention, and are not intended to limit the scope of the present invention. Any equivalent variation and modification made by persons skilled in the art without departing from the spirit and scope of the present invention shall fall within the appended claims of the present invention.

What is claimed is:

1. A plug-and-play barcode scanner, in an information link with an electronic apparatus and operative to scan a barcode, comprising:
a barcode scan module, having a barcode scanning function;
a transmission interface module, electrically connected to the barcode scan module and capable of being plugged into the electronic apparatus and transferring barcode information obtained by the barcode scan module to the electronic apparatus; and
an operating key, electrically connected to the barcode scan module for operating the barcode scan module to scan the barcode.

2. The plug-and-play barcode scanner according to claim 1, wherein the barcode scan module is formed of at least one light-emitting source, a lens set and a receiving unit.

3. The plug-and-play barcode scanner according to claim 1, wherein the transmission interface module is a USB interface.

4. The plug-and-play barcode scanner according to claim 1, wherein the electronic apparatus is a computer.

5. The plug-and-play barcode scanner according to claim 1, wherein the electronic apparatus is a portable communication apparatus.

6. The plug-and-play barcode scanner according to claim 1, wherein a cover body covers the transmission interface module.

7. The plug-and-play barcode scanner according to claim 1, wherein a pivot is configured between the barcode scan module and the transmission interface module, so that the barcode scan module and the transmission interface module are capable of rotating relative to each other.
